(19) United States
(12) Patent Application Publication
(10) Pub. No.: US 2009/0089105 A1
(43) Pub. Date: Apr. 2, 2009

(54) DISPATCHING CAR APPARATUS AND OPERATION METHOD THEREOF

(75) Inventor: Jen-Chang WU, TAIPEI CITY (TW)

Correspondence Address: Chih Feng Yeh;BRIAN M. MCINNIS, 12th Floor, Ruttonjee House, 11 Duddell Street, Hong Kong, HK

(73) Assignee: SHIH PI TA TECHNOLOGY LTD., TAIPEI CITY (TW)

(21) Appl. No.: 12/243,978

(22) Filed: Oct. 2, 2008

(30) Foreign Application Priority Data
Oct. 2, 2007 (TW) 96136973

(51) Int. Cl. G06Q 10/00

(52) U.S. Cl. 705/5

(57) ABSTRACT

A dispatching apparatus is disclosed. The apparatus comprises a receiving module to receive the necessary car requirements from the passenger, wherein the necessary car requirements includes the condition of car and driver required by the passenger; a dispatching module for receiving the necessary car requirements; a memory unit storing information of cars and drivers of the dispatching companies, the dispatching module can compare the requirement with the information to select at least one car; and a wireless transferring network for broadcasting the necessary car requirements to at least one car and receiving responses from at least one car.

### RELATED APPLICATIONS

This application claims priority to Taiwan Application Serial Number 96136973, filed Oct. 2, 2007, which is herein incorporated by reference.

### FIELD OF THE INVENTION

The present invention relates to dispatch cars, and especially to a method to dispatch a car to passengers.

### BACKGROUND OF THE INVENTION

Typical taxi drivers drive their own cars to find their own passengers. However, such a business model is very inefficient because it often occurs that many taxis are concentrated in a special business region to find passengers. In this case some taxis located in the special business region cannot find passengers and the passengers located out of the special business region cannot find a taxi. Therefore, a dispatching company integrates many taxis to solve the above problem.

According to the dispatching business model, a passenger can call the dispatching company to tell the company he needs a taxi. Then, the dispatching company broadcasts the necessary information to all the taxis that belong to the company through a radio frequency. At this time, when a taxi is near the passenger looking for a taxi and the taxi is not carrying any passengers in his car, the driver can make a response to the company to take this passenger.

However, due to the limitation of the radio frequency, only 300 taxis can receive the necessary car information. In other words, a dispatching company can only integrate 300 taxis at best. Such limitations reduce the service quality.

One method is to set a dispatching company union to solve the above problem. The union integrates some dispatching companies. When a passenger calls the union to tell he needs a taxi, the union can send the necessary car information to the taxis belong to these dispatching companies integrated to the union. Such method can enlarge the service range. However, it is very difficult to integrate dispatch companies.

The other method is to set a dispatching center with a united telephone number for dispatching companies. The passenger only needs to call the telepnone number to tell them he/she needs a taxi. Then, the dispatching center can send the the necessary information to one of the dispatching companies to dispatch a taxi to take this passenger. However, according to this method, determining which dispatching company to send the information to is a problem that first has to be solved.

Moreover, some passengers may need a special taxi that has equipment for disabled people. However, not all dispatching companies have such taxis. Therefore, these passengers have to try to call every dispatching company to find such taxi, which is very inconvenient for passengers.

Therefore, it is a target to improve the service quality.

### SUMMARY OF THE INVENTION

Therefore, the purpose of the present invention is to provide a dispatching car apparatus and operation method thereof. The dispatching car apparatus and operation method thereof disclosed in this embodiment can improve the service quality and maintain the independence of the dispatching companies.

The purpose of the present invention is to provide a dispatching car apparatus and operation method thereof that can dispatch cars belonging to different dispatching companies to improve efficiency.

In accordance with the foregoing purpose, the present invention discloses a dispatching apparatus. The dispatching apparatus can dispatch cars belong to different dispatching companies. The apparatus comprises a receiving module, a dispatching module, a memory unit and a wireless transferring network. The dispatching module receives necessary car information that includes information about the required taxi and passenger information. The dispatching module receives the necessary taxi and passenger information. The memory unit is coupled to the dispatching module and stores the car and driver information. The dispatching module can also compare the required taxi information with the information of the cars and the drivers stored in the memory to select at least one of the cars. The wireless transferring network broadcasts necessary car information to at least one car and receives information from at least one car.

According to another embodiment, the dispatching apparatus further comprises a plurality of input interfaces belonging to different dispatching companies to input the necessary car information to the receiving module.

According to another embodiment, the present invention discloses a dispatching car method. The method can dispatch cars belonging to different dispatching companies. The method comprises receiving necessary car information that includes both the required taxi information and the passenger information, selecting at least one of the cars based on the required taxi information to compare with the information of the cars and the drivers stored in a memory, and broadcasting the necessary car information to at least one of the selected cars.

According to the present invention, when a passenger issues the necessary car information through the web-site or the switchboard of a special dispatching company, the taxis of the special dispatching company are dispatched first by the dispatch system. The taxis belong to other dispatching companies are dispatched only when no taxi can be dispatched with the special dispatching company. Therefore, this invention not only keeps every dispatching company operating individually but also improves the dispatching efficiency.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of the dispatching apparatus of the present invention.

FIG. 2 illustrates an example of selecting a car according to the present invention.

FIG. 3 illustrates an example of using the dispatching apparatus of the present invention and a conventional dispatching apparatus to dispatch a car with special equipment.

FIG. 4 illustrates an example of using the dispatching apparatus of the present invention to dispatch a car with special equipment.

FIG. 5 illustrates an example of recording the car.

### DETAILED DESCRIPTION OF THE PREFERRED EMBODIMENT

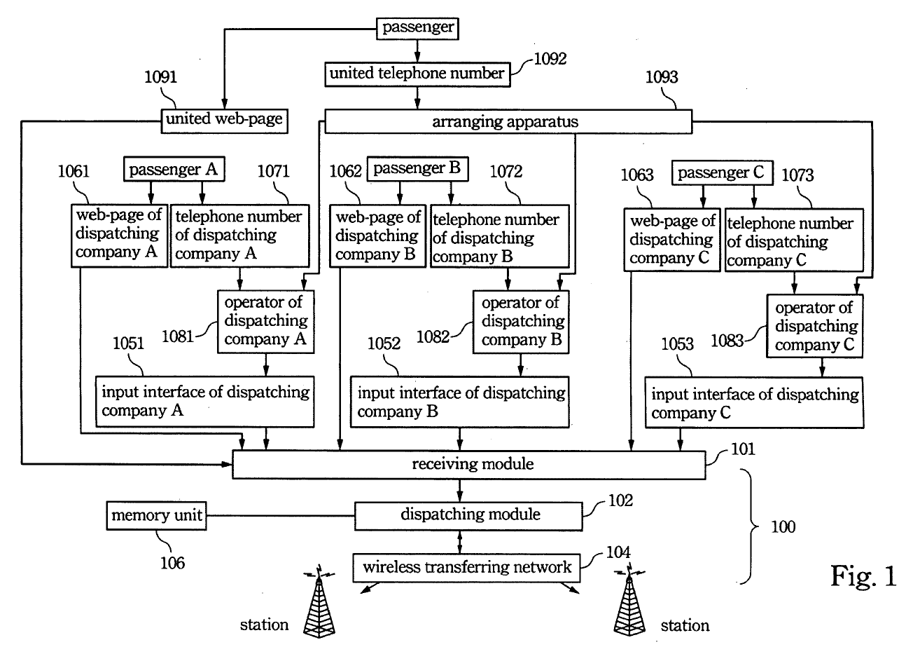

FIG. 1 is a schematic diagram of the dispatching apparatus of the present invention. The present invention discloses a dispatching apparatus 100. The dispatching apparatus 100 includes a receiving module 101, a dispatching module 102, a wireless transferring network 104 and a memory unit 106. The receiving module 101 allows users to input necessary car information that includes special requirement for a taxi from the passenger and the information of the passenger. The necessary car information is sent to the dispatching module 102. The memory unit 106 stores the information of the cars and the drivers. The dispatching module 102 compares the special requirement from the passenger with the information stored in the memory unit 106 to select at least one of the cars. Then, the necessary car information is broadcast to at least one car and receives information from at least one car through the wireless transferring network 104.

The receiving module 101 enables users to input necessary car information that includes special requirement for a taxi from the passenger and the information of the passenger. The special requirement for a taxi includes the place and the time of the passenger taking the taxi, the destination, the type of taxi and the driver. The type of taxi further includes the engine type, the trunk size, the seating capacity, the age of the car, the equipment of the car and so on. The information of the drivers includes the ability of the foreign language, the sex and age of the driver, and the driving record. The passenger information includes the name, telephone and so on.

The necessary car information is inputted from the input interfaces 1051, 1052 or 1053 of dispatching companies to the receiving module 101. In an embodiment, a passenger can call a telephone number 1071, 1072 or 1073 to tell the corresponding operator 1081, 1082 or 1083 the necessary car information. Each dispatching company has an independent telephone number. The content of the necessary car information is inputted to the input interfaces 1051, 1052 or 1053 by the operator 1081, 1082 or 1083. In other embodiment, a voicemail can be used to replace an operator. The passenger can input the necessary car information to the voicemail. In another embodiment, a passenger can input the content of the necessary car information in a web-page 1061, 1062 or 1063. Then, the content is directly transmitted to the receiving module 101.

On the other hand, in an embodiment, a united telephone number 1092 is provided to a passenger. The passenger can use this united telephone number to tell he/she needs a taxi. Then, the arranging apparatus 1093 transfers this call to the operator 1081, 1082 or 1083 based on a rule. In this embodiment, the operator receiving the transferred call is responsible for input the necessary car information to the receiving module 101 through the corresponding interface. In another embodiment, other communication methods, such as E-mail, MMS, SMS, instant messaging and so on, are also provided to the passenger to communicate with the operator to request a taxi.

The rule to transfer the call to the operator 1081, 1082 or 1083 from the arranging apparatus 1093 is based on the order of the call. For example, the first call is transferred to the operator 1081, the second call is transferred to the operator 1082 and the third call is transferred to the operator 1083. In another embodiment, the rule is based on the negotiation made by the dispatching companies. For example, the first, the second and the fifth call are transferred to the operator 1081, the third and the seventh call are transferred to the operator 1082 and the fourth and the eighth call are transferred to the operator 11083. Or, all calls are transferred to the same operator and this operator is responsible for inputting the necessary car information into the receiving module 101. Then, the other dispatching companies pay the service charge to the operator's dispatching company. In this embodiment, only one operator is needed. Therefore, the personnel cost is reduced. Moreover, in another embodiment, the rule is based on the time to transfer the call. For example, the calls calling in different time are transferred to different operators. Or, the rule is based on the number of cars that the dispatching company has. For example, the more cars the dispatching company has, the more calls are transferred to this dispatching company.

The dispatching module 102 couples with the receiving module 101. The necessary car information is sent to the dispatching module 102 from the receiving module 101. The memory unit 106 stores the information of the cars and the drivers. The dispatching module 102 compares the special requirement from the passenger with the information stored in the memory unit 106 to select at least one of the cars. When more than one cars are selected, the necessary car information is broadcasted to the drivers of the cars and receives information from the drivers of the cars through the wireless transferring network 104. In that case, the driver responding to the information first can take the passenger. In another embodiment, the necessary car information informs the drivers one by one to ask each driver whether or not they can take the passenger. In this case, the dispatching module 102 asks the driver first belonging to the dispatching company that receives the call from the passenger. When this dispatching company cannot dispatch a car to the passenger, the driver of another dispatching company is asked then. In this case, an asking order rule is also set.

Moreover, a receiver and transmitter apparatus are installed in the car to receive the information from the dispatching module 101 and to send the information of the driver to the dispatching module 101 through the wireless transferring network 104. The communication technology used in the radio and the cellphone can also be applied to the present invention.

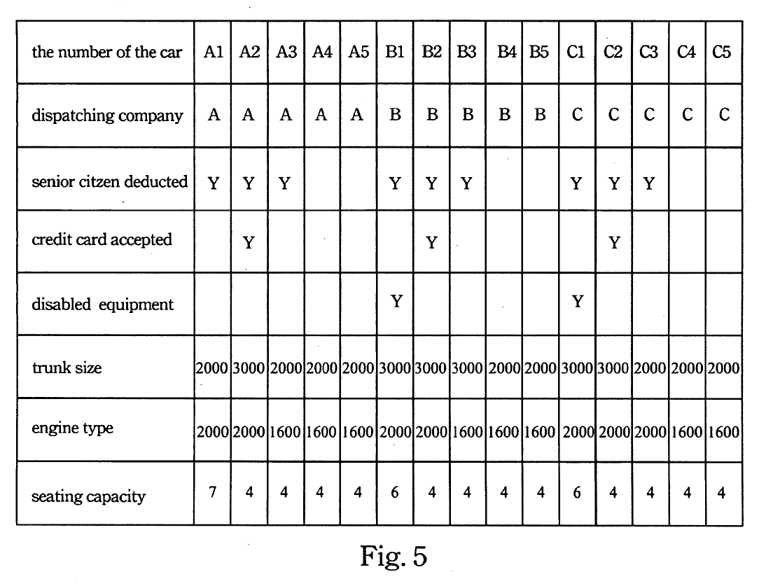

The memory unit 106 stores the information of the cars and the drivers. This information is built by the dispatching company. FIG. 5 shows an example to record the car.

In another embodiment, physical conditions are taken into account to select the cars. For example, the physical conditions include the distance of the car from the passenger, the standby time of the car, the distance having carried the passenger and so on.

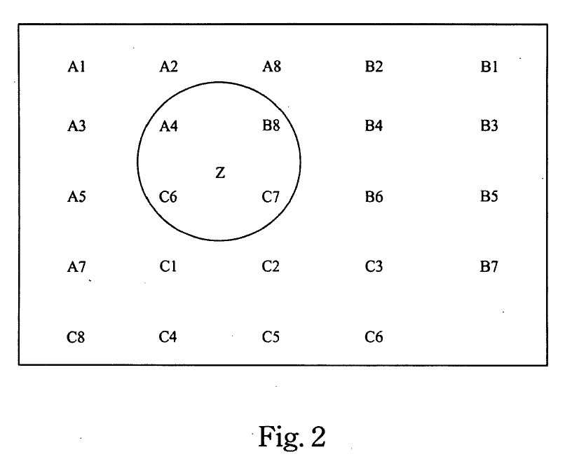

FIG. 2 illustrates an example to select a car. A1˜A8, B1˜B8 and C1˜C8 are the number of the cars. The cars A1˜A8 belong to the dispatching company A. The cars B1˜B8 belong to the dispatching company B. The cars C1˜C8 belong to the dispatching company C. A passenger calls the dispatching company a to ask for a car in position Z and specifies the condition of the car. Because the dispatching company A receives the call, the car A4 is sent to take the passenger. However, if the car A4 does not fit the specified conditions or the driver of the car A4 rejects taking the passenger, the dispatching module 102 can automatically dispatch the car B8, the car C6 or the car C7 to take the passenger. If all the cars B8, C6 and C7 fit the specified conditions, in an embodiment, the order to dispatch the car B8, the car C6 or the car C7 is based on the rules, such as the distance form the passenger, the standby time, the responding time from the driver and so on.

According to the method, when a passenger calls a specific dispatching company a to ask for a car, the cars belonging to this dispatch company are dispatched first by the system of the present invention. When this dispatch company cannot dispatch any car to the passenger, the system dispatches the cars of other dispatching companies to the passenger. Therefore, the independent operation of each dispatching company can be kept according to the present invention. Moreover, the cooperation of dispatching companies is improved. On the other hand, although a united telephone number is provided to passengers to call cars, the calls from the passengers are transferred to dispatching companies based on a rule agreed by them. Then, the operator of each dispatching company inputs the necessary car information through the independent interface to the receiving module 101. Therefore, the independent operation of each dispatching company can be kept. Moreover, when a passenger needs a car having disabled equipment, he only needs to call the united telephone number to find the car, which provides a friendly interface for the passenger.

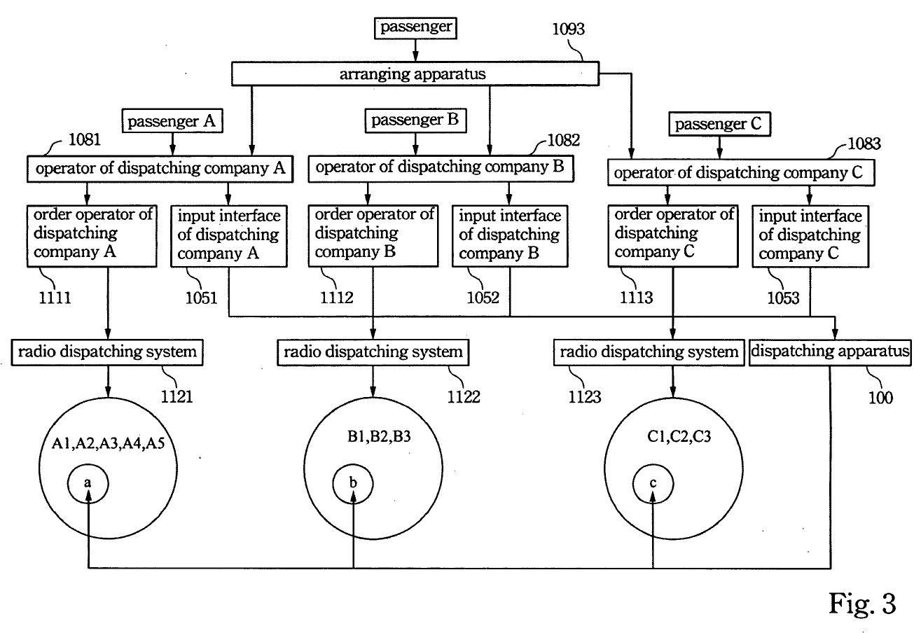

In another embodiment, the dispatching apparatus of the present invention can cooperate with a conventional radio dispatching system. FIG. 3 illustrates an example to use the dispatching apparatus of the present invention and a conventional radio dispatching system to dispatch a car with special equipment. In this embodiment, when a passenger needs a car with special equipment, the passenger can call an operator 1081, 1082 or 1083 through a corresponding telephone number to tell operator the necessary car information. In another embodiment, a united telephone number is provided to a passenger. The passenger can use this united telephone number to tell the arranging apparatus 1093 he needs a taxi. Then, the arranging apparatus 1093 transfers this call to the operator 1081, 1082 or 1083 based on a rule to inform the order operator 1111, 1112 or 1113 the necessary car information. The order operator 1111, 1112 or 1113 can dispatch the cars using the conventional radio dispatching system 1121, 1122 or 1123. For example, the order operator 1111 can dispatch the car A2 from the cars A1˜A5 using the conventional dispatching system 1121. Or, the order operator 1111, 1112 or 1113 can input the necessary car information to the dispatching apparatus 100 through the input interfaces 1051, 1052 or 1053 to dispatch a car. In this case, the car is selected from the cars A1˜A5, B1˜B3 and C1˜C3.

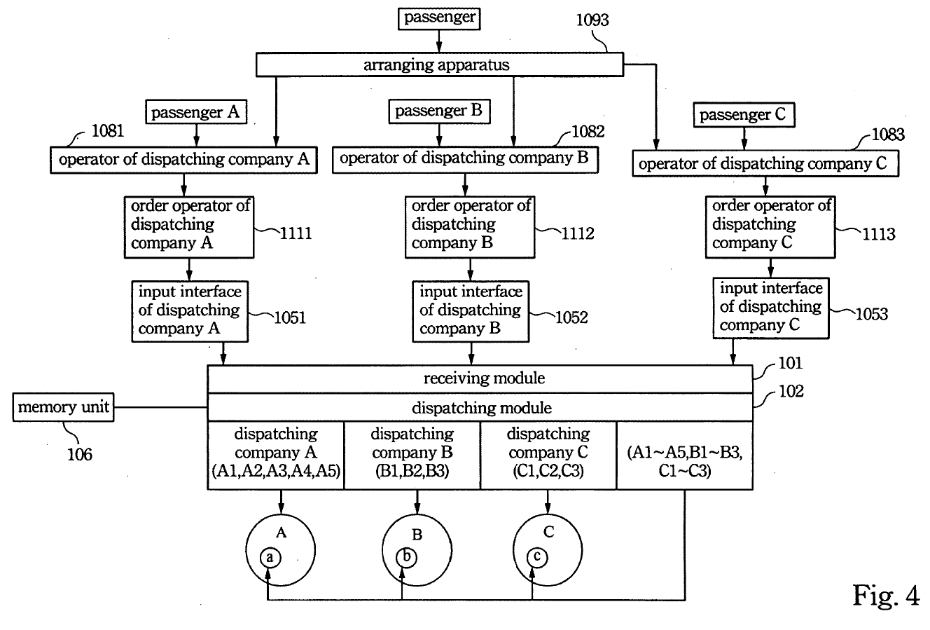

FIG. 4 illustrates an example to use the dispatching apparatus of the present invention to dispatch a car with a special equipment. In this embodiment, when a passenger needs a car with special equipment, the passenger can call an operator 1081, 1082 or 1083 through corresponding telephone number to tell him the necessary car information. In another embodiment, the passenger can use this united telephone number to tell the arranging apparatus 1093 he needs a taxi. Then, the arranging apparatus 1093 transfers this call to the operator 1081, 1082 or 1083 based on a rule to inform the order operator 1111, 1112 or 1113 the necessary car information. The order operator 1111, 1112 or 1113 can input the necessary car information to the dispatching module 101 through the input interfaces 1051, 1052 or 1053. Then, the necessary car information is sent to the dispatching module 102 from the receiving module 101. The memory unit 106 stores the information of the cars and the drivers. The dispatching module 102 compares the special requirement from the passenger with the information stored in the memory unit 106 to select the cars. In this case, the selected car are the cars A1˜A5, B1˜B3 and C1˜C3. Then, the necessary car information is broadcast to the drivers of the cars A1˜A5, B1˜B3 and C1˜C3 through the wireless transferring network 104.

As is understood by a person skilled in the art, the foregoing preferred embodiment of the present invention is illustrative rather than limiting of the present invention. It is intended to cover various modifications and similar arrangements included within the spirit and scope of the appended claims, the scope of which should be accorded the broadest interpretation so as to encompass all such modifications and similar structure.

While the preferred embodiment of the invention has been illustrated and described, it will be appreciated that various changes can be made therein without departing from the spirit and scope of the invention.

What is claimed is:

1. A dispatching apparatus for dispatching cars belonging to different dispatching companies to a passenger, the apparatus comprising:
a receiving module to receive the necessary car requirements from the passenger, wherein the necessary car requirements includes the condition of car and driver required by the passenger;
a dispatching module for receiving the necessary car requirements;
a memory unit coupling with the dispatching module, wherein the memory unit stores information of cars and drivers of the dispatching companies, the dispatching module can compare the requirement with the information to select at least one car; and
a wireless transferring network for broadcasting the necessary car requirements to at least one car and receiving responses from at least one car.

2. The apparatus of claim 1, further comprising a plurality of receiver/transmitter units installed in the cars to receive the necessary car requirements and to send responses from the driver of the cars.

3. The apparatus of claim 1, further comprising a plurality of input interfaces belonging to the different dispatching companies for inputting the necessary car requirements to the receiving module.

4. The apparatus of claim 1, wherein the passenger inputs the necessary car requirements to the receiving module through a web-page, wherein one of the dispatching companies has the web-page or the dispatching companies have the web-page together.

5. The apparatus of claim 1, wherein the passenger calls a telephone number to input the necessary car requirements to the receiving module, wherein one of the dispatching companies has the telephone number or the dispatching companies have the telephone number together.

6. The apparatus of claim 5, further comprising an arranging apparatus, wherein when the passenger calls the telephone number belonging to the dispatching companies together, the arranging apparatus transfers the call to one of the dispatching companies based on a rule, wherein the rule is set based on the number of cars that the dispatching companies have, the data and the order of the calls.

7. The apparatus of claim 1, wherein the necessary car requirements are sent to the receiving module through an E-mail, MMS, SMS or an instant message.

8. The apparatus of claim 1, wherein the condition of the car includes the engine type, the trunk size, the seating capacity, the age of the car, the equipment of the car.

9. The apparatus of claim 1, wherein the condition of the driver includes the ability of the foreign language, the sex and age of the driver, and the driving record.

10. The apparatus of claim 1, wherein at least one car is selected by the dispatching module from the cars belonging to a dispatching company that receives the necessary car requirements from the passenger, wherein when the dispatching company cannot dispatch a car, then, a car of other dispatching companies are selected by the dispatching module.

11. A dispatching method for dispatching cars belonging to different dispatching companies to a passenger, the method comprising:
receiving the necessary car requirements from the passenger, wherein the necessary car requirements includes the condition of the car and driver required by the passenger;
comparing the requirement with the information stored in a memory unit to select at least one car; and
broadcasting the necessary car requirements to at least one car and receiving responses from at least one car.

12. The method of claim 11, further comprising inputting the necessary car requirements to the receiving module.

13. The method of claim 11, further comprising inputting the necessary car requirements to the receiving module through a web-page, wherein one of the dispatching companies has the web-page or the dispatching companies have the web-page together.

14. The method of claim 11, further comprising calling a telephone number to input the necessary car requirements to the receiving module, wherein one of the dispatching companies has the telephone number or the dispatching companies have the telephone number together.

15. The method of claim 11, further comprising to transfer this call to one of the dispatching companies based on a rule when the passenger call the telephone number belonging to the dispatching companies together.

16. The method of claim 15, wherein the rule is set based on the number of cars the dispatching companies have, the data and the order of the calls.

17. The method of claim 11, wherein the necessary car requirements are sent to the receiving module is through an E-mail, MMS, SMS or an instant messaging.

18. The method of claim 11, wherein the condition of the car includes the engine type, the trunk size, the seating capacity, the age of the car, the equipment of the car.

19. The method of claim 11, wherein the condition of the driver includes the ability of the foreign language, the sex and age of the driver, and the driving record.

20. The method of claim 11, wherein at least one car is selected from the cars belonging to a dispatching company that receives the necessary car requirements from the passenger, wherein when the dispatching company cannot dispatch a car, then, a car of the other dispatching companies are selected.
